(19) United States
(12) Patent Application Publication
(10) Pub. No.: US 2009/0206609 A1
(43) Pub. Date: Aug. 20, 2009

(54) Hydro electrical plant

(75) Inventor: Jonathan Eugene Wood, Goleta, CA (US)

Correspondence Address: Jonathan Eugene Wood, 175 Kinman Ave Ap 5 Goletia, Goleta, CA, 93117, US

(73) Assignee: Jonathan Eugene Wood

(21) Appl. No.: 12/148,495

(22) Filed: Apr. 21, 2008

Related U.S. Application Data
(60) Provisional application No. 60/934,002, filed on Jun. 11, 2007.

(51) Int. Cl. F03B 13/08; F03B 17/04

(52) U.S. Cl. 290/54; 415/916

(57) ABSTRACT

The process of the Hydro Electrical Plant is unique in these ways. The plant reuses the water it uses to produce electrical energy. The process is a type proportional motion that has never been invented at this high as level, being able to produce so much electricity in one unite. This process dose not produce chemical heat like in heat fusion such as coil power plants and nuclear power plants. Hydro electrical power plans such as Barbary dam lets the water run free down the river, the Hydro Electrical Plant reuses the water to recreate more electricity. The Hydro Electrical Plant Land can also be built away from rivers and lakes our the ocean. But the Hydro Electrical Plant water mass can be built in the ocean, lakes our artificial lakes.

The process is safe from radiation like nuclear waste that last for million years. It dose not use large amounts of fresh water that is burned up as steam. Coil and oil require elements that must be drilled our removed from the earth and they use heat steam to turn the steam turbine that burn up fresh water and smoke into the ozone layer. The Hydro Electrical Plant is clean for the environment and produces a clean cheap electricity product.

The Hydro Electrical Plant is built with common building materials such as concrete, steal rebar, wood, glass, plastics, metal, water, foam and other materials. The Hydro Electrical Plant uses a process, this process can be converted into many different forms depending on the application it is going to be used for. The main idea is the process or the way it works.

I think that the Hydro Electrical Plant is a safe practical modern way to produce electrical energy with out pollution our radiation. This machine makes electricity with running water free from pollution our chemical radiation. The pollution free electricity and air is the products that make this invention machine unique to other machine methods of making electrical power. The size of the application of the Hydro electrical Plant depends on the way that it is going to be used. The size can vary from vary big to hug our to vary small to tiny. Water is the main fuel but other liquids can be used as other fuel sources. The water is replenished throw external water sources.

The Hydro Electrical Plant has several ways to exist from big to small on land and sea. The next pages of this portfolio will show the process that produces the electrical power and the workings that go on inside the Hydro Electrical Plant. This method I think is unique and safe, I estimate that one Hydro Electrical power generator can supply for ten thousand homes. At this rate one hundred and fifty generators would supply one million five hundred thousand homes with pollution free electrical power. To produce energy with out pollution our toxic side effects would help safe guard our land. This I think is a practical way of producing electrical energy, that is free from harmful pollution and radiation that might other wise harm us are the word. The ability to produce electrical power with out toxic waste, will lower I think the price of electrical energy. The environmental impact would be less pollution. This would help against a melt down like mile high. I estimate that one Three Fifty Hydro Electrical Plant will pay for its self in ten years of operation.

The Three Fifty Electrical Plant application is able to be built side by side. This application of the Hydro Electrical Plant gives the region it is built in one hundred and fifty electrical generators per Three Fifty Hydro electrical insulation. This if two where built side by side three hundred generators would supply the electrical energy. So if three Hydro Electrical Power Plants are built side by side four hundred and fifty generators that would supply electrical energy, our to the regions needs of the Hydro Electrical Plant.

The Hydro electrical Plant can be closed our encased. The smaller the plant becomes the more easily it is to enclose. This would seal the unit as one whole. The Hydro Electrical Plant has different applications that can be enclosed our encase. I will use the Water Mass application and the Land application to show the process that makes the Hydro Electrical Plant unique.

1. This invention I think belongs to the hydro electrical invention class. The process of making clean electricity with water that is able to be reused. This process uses water fills to turn the Hydro Electrical Generators that create the electrical power. The way the power is made is clean from pollution. It is this clean method that makes this process unique to other methods. The electricity being safe, runs the power plant operations as well as the electrical powered water pumps. As it goes this power plant will create more power than it uses.

2. There are other types of hydro electrical plants. Theses plants are usually built on river our lakes. For example Bradbury dam and Niagara falls. Both use hydro electrical generators to produce the electricity. The different is that the water is released down the river. In the Hydro Electrical Plant the water is reused There are servile ways to show the process or the method of this invention I will use the Hydro Electrical Plant water mass and the Hydro Electrical Plant land. Both of these methods use a similar method of Producing electrical energy. The water mass plant uses a cylinder that is submerged in the water mass. By submerging the cylinder, this creates a water fall effect from the main water source. This water fall runs down a spillway over a generator turn bind that turns the generator. By turning the generator this creates electricity that run the operations in the power plant. The water then falls into a catch basin at the bottom of the cylinder. This basin fills to the correct level then the electrical power water pumps that are built into the wall of the power plant pump the water back into the main water source, this is what keeps the water from over flowing in the catch basin. The process is repeated over and over again producing clean electrical power.

3. The other similar method of producing electrical power is the Hydro Electrical Land. This method is vary similar as the cylinder method, the different is that it is built on land and that instead of cylinders we use dams to produce the water fall. It is the dams that holds the electrical generators that produce the clean electrical power. The water fills up in the first reservoir to the top of the dam. At the top of the dam there are spillways, when the water reaches the spill ways they open. This will allow the water to spill down the dam over the electrical generators that produce the electrical power. After the water reaches the bottom of dam, a catch basin catches the water. This water fills up to the correct water levels. At this point the electrical water pumps start pumping the water out of the catch basin into reservoir two. Reservoir two fills up with water higher than the dam and higher than reservoir one. At this point the water, because of gravity creates a back spill into reservoir one. At this point the power plant would be filled with water. The water would then keep reservoir one filled up to spillway gates, to be used as the fuel again.

4. The Hydro Electrical Plant land also has Reservoir Balloons. The Reservoir Balloons inflate and deflate as the water evaporates out and is refilled throw an external water source. The Hydro Electrical Plant Land can also be connected to make a malt able connections that will render more electricity from having more hydro electrical generators. The ability to be connected together will produce supper amounts of electrical energy.

### SUMMARY OF THE PRESENT INVENTION

5. The Hydro Electrical Plant has a relation to other hydro electrical power plants such as Bradbury dam and Niagara falls power plant. These invention uses water and gravity to turn electrical generators to make a clean electricity product that is clean and cheap. The method is safe from radiation and smoke pollution. The water in the reservoirs are safe for biological life such as fish and moss. The amount of electricity is able to run mega cities The way the water is reused in the Hydro Electrical plant is a unique way to produce electricity and is the difference from the other two examples. The Hydro Electrical plant can be built on land and in the ocean or lakes. The size can vary from vary big to vary small. The generators being built on top of one another increase out put of electricity energy. The dams having different levels that can hold many electrical generators. These generators are built into the dam, the bigger the dam the more generators are able to be built into the Hydro Electrical Plant.

### BRIEF DESCRIPTION OF THE DRAWING FIGURE

These figures show the process and workings that go on inside the Hydro Electrical Plant. The different ways the water flows throw the plant in the water mass plant and in the land plant. There are different ways to apply the Hydro Electrical Plant process. The process is unique clean and safe.

FIG. 1. Side views of the process of the water mass plant.

FIG. 2. Side view of the process of the Hydro Electrical Plant land.

FIG. 3. Side view of the reservoir balloons.

FIG. 4. Side view of the connection application and process of the Hydro Electrical Plant land.

FIG. 5. Top view of the connection application and process of the Hydro Electrical Plant land.

### DESCRIPTION OF THE REFERENCED NUMERALS OF THE WATER MASS PLANT

1. Water from main source and top spillways.

2. Spillways and electrical generators.

3. Electrical generator housing areas.

4. The catch basin.

5. The electrical water pumps.

6. Cover plate.

7. The up draft air vent.

### DESCRIPTION OF THE REFERENCED NUMERALS OF LAND PLANT

1. First reservoir and top spillways.

2. Top spillways and onto dam one generator fins.

3. Spillways and generators fins.

4. The Electrical generator housing areas.

5. The catch basin.

6. The one way electrical pumps.

7. Water reservoir two and top back spillways.

8. The reservoir is built higher than reservoir one.

9. The top spillways from reservoir two to reservoir one.

### DESCRIPTION OF THE REFERENCED NUMERALS RESERVOIR BALLOONS

1. Reservoir balloons.

2. The top spillways and water reservoir.

3. Reservoir.

4. Air pump housing area.

5. Over flow to the out side.

### DESCRIPTION OF THE REFERENCED NUMERALS CONNECTION APPLICATION

1. First reservoir and top spillways.

2. Top spillways and generator fins.

3. The spillways with electrical generators.

4. The electrical generator hosing holding areas in dam one.

5. The catch basin one.

6. One way electrical pumps in catch basin one.

7. Second reservoir and the second top spillways.

8. Second top spillways and generator fins.

9. The second spillways down the second dam and generator fins.

10. Electrical housing in second dam.

11. Catch basin two.

12. One way electrical pumps in catch basin two.

13. Third reservoir and top spillway.

14. The third top spillway and generator fins.

15. The third spillways and electrical generator fins.

16. The electrical housing areas in the third dam.

17. Catch basin three.

18. One way electrical pumps in catch basin three.

19. Fourth reservoir and top back spillways.

20. Back spillways from reservoir four to reservoir.

21. First generator levels.

22. Over flow.

### DETAILED DESCRIPTION OF THE PREFERRED EMBODIMENT

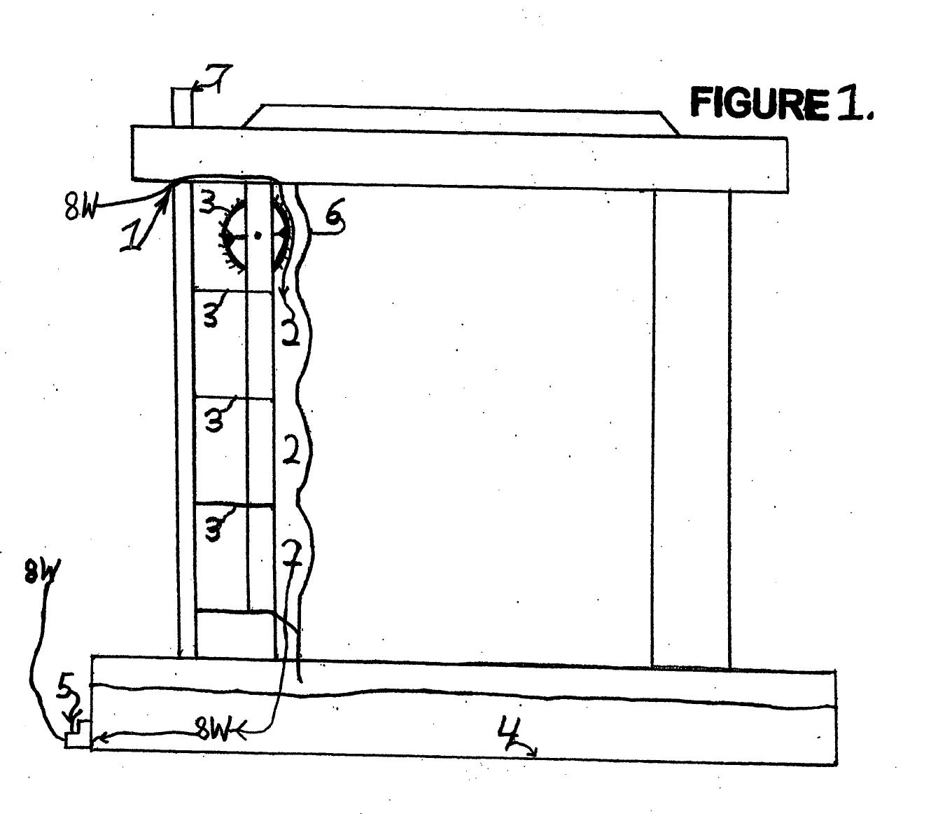

The process in the Hydro Electrical plant water mass is numbered as is below. This will show the workings of the process that go on inside the plant see, FIG. 1.

1. Water mass, lake our ocean water, water runs into water mass plant spill ways into electrical generators.

2. Water from spillway fills down into electrical generators, spinning the electrical generators. This creates the electricity.

3. Electrical generator housing, the Hydro Electrical Generators are stored on top of one another. This lets the water fall down like a water fall down on top of the generator below its self until the water falls into the catch basin.

4. The catch basin, catches the water that falls throw the spillway and throw the generators.

5. Electrical water pumps built into the walls of the catch basin pumps the water out from inside the catch basin back into the main water mass.

6. Cover plate, the cover plate keeps the water flowing down throw the generators.

7. Up draft air vent, air vents allow the air from falling water into the catch basin to vent out the top of the Hydro Electrical Plant water mass.

8. W arrows=water flow.

### DETAILED DESCRIPTION OF THE PREFERRED EMBODIMENT

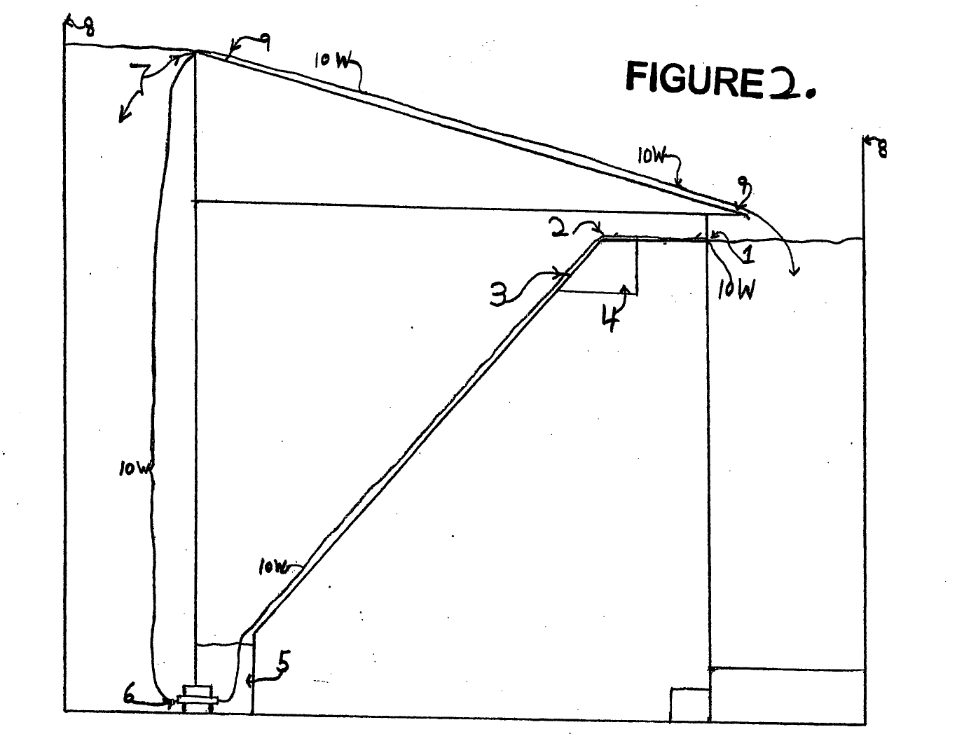

The process in the Hydro Electrical Plant land is numbered as below. This this will show the workings of the process that go on inside the plant see, FIG. 2.

1. First reservoir fills up with water to the spillway.

2. Water opening onto the spillway, runs down the dam over the generator fins turning the electrical generators creating the electricity.

3. The spill way opens onto the spillway down the dam over the generator fins creating the electricity.

4. Electrical generator housing areas, generators are housed on top of one another and side by side.

5. Water spills down the spillway over the electrical generators down the dam into the catch basin.

6. One way electrical pumps built into the catch basin wall, pumps the water out of the catch basin into reservoir two.

7. Water reservoir two fills up with water to the top.

8. Reservoir two is higher than reservoir one this creates a back fill from reservoir two into reservoir one.

9. Top back spillway runs from reservoir two back into reservoir one. The water flows from reservoir two down top spillway into reservoir one. This refills reservoir one with water, then back into spillway into the electrical generators that makes the electricity again with the same water.

10. W Arrows=water flow.

### DETAILED DESCRIPTION OF THE PREFERRED EMBODIMENT

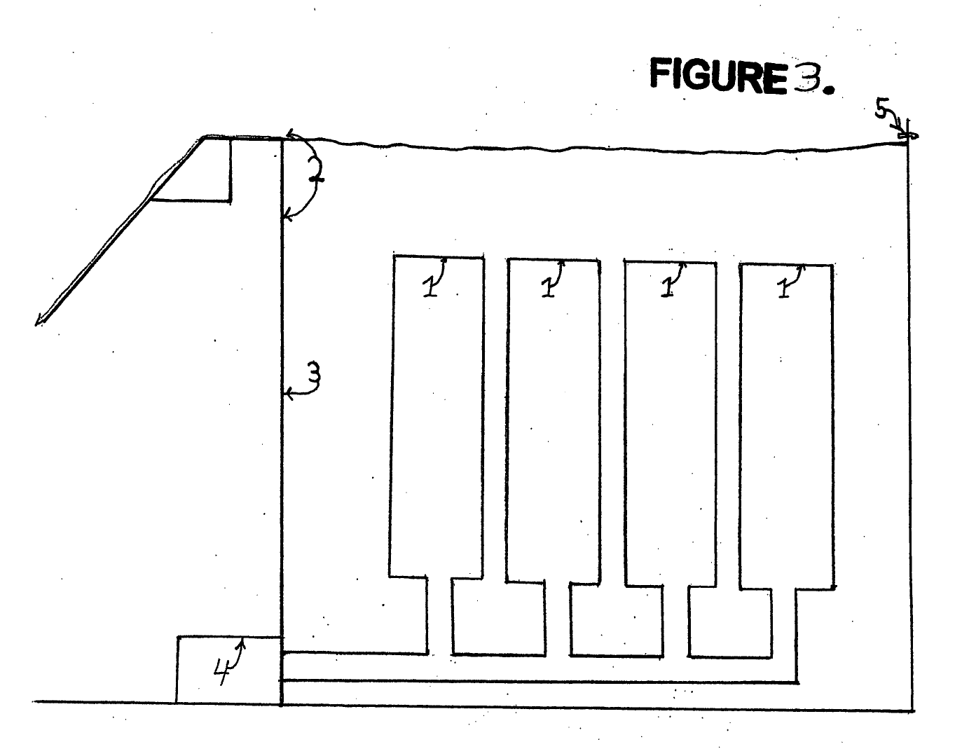

The process in the Reservoir Balloons is numbered as is below. This will show the working of the process that go on inside the reservoir see, FIG. 3.

1. Reservoir balloons inflate and deflate controlling the water level in the reservoir.

2. Water opening onto spillway, runs down the dam over the generators fins turning the electrical generators creating the electricity.

3. Water fills up to spillway.

4. Air pump housing, houses the air pumps that inflate and deflate the reservoir balloons.

5. Over flow to the out side.

6. W Arrows=Water flow.

### DETAILED DESCRIPTION OF THE PREFERRED EMBODIMENT CONNECTION APPLICATION

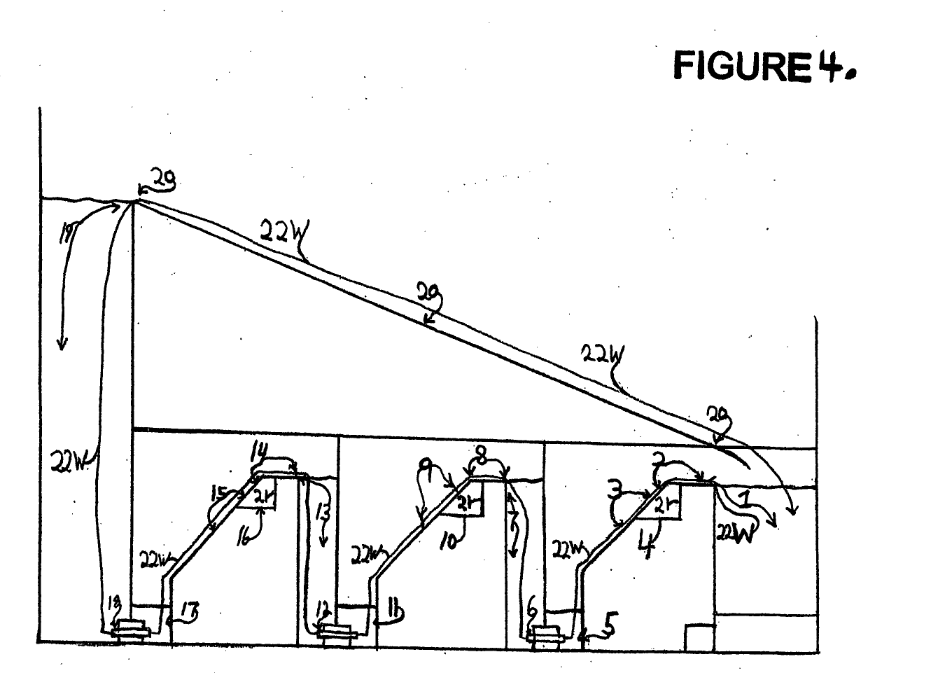

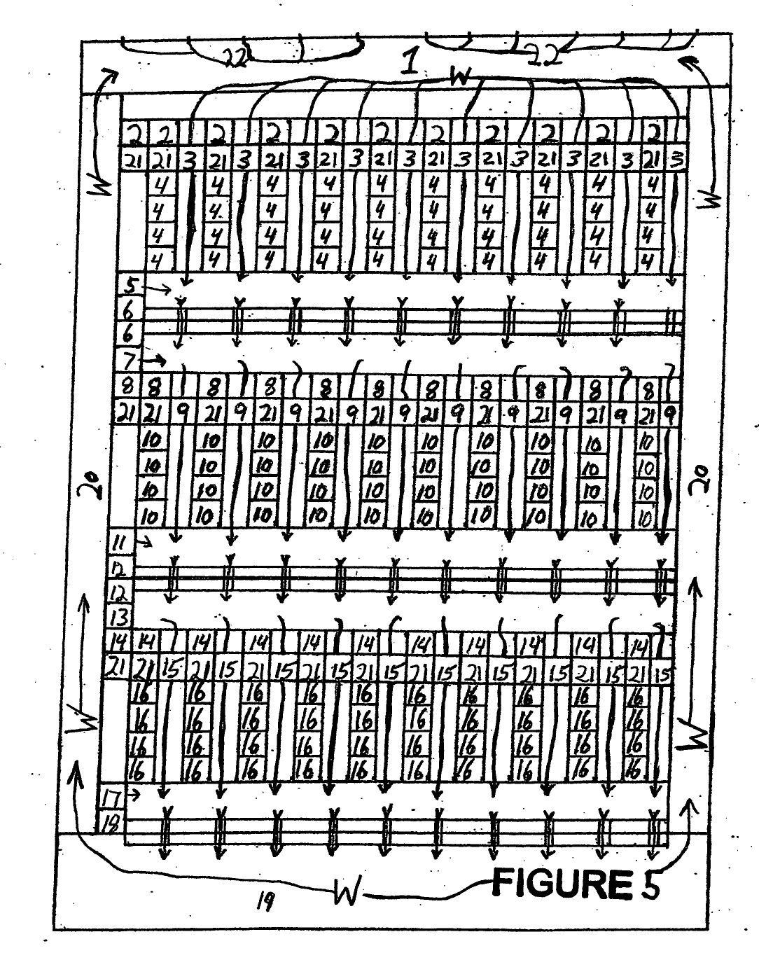

The process in the Connection Application is numbered as is below. This will show the workings of the Process that go on inside the connection application, see FIG. 4. AND FIG. 5.

1. First reservoir fills up with water up to spillway one.

2. Water opening onto spillway one spills over spillways down the dam one over generator fins turning the generators causing electricity.

3. Spillway generator fins turn when the water from the spillway spills down dam turning the generators making the electricity.

4. Electrical generator housing areas. Electrical generators are housed on top of one another and side by side in side the dam.

5. Catch basin one catches the water that spills down spillways one over the generator fins. Catch basin one fills to correct water levels.

6. One way electrical pumps that are built into the catch basin one walls pump the water out of catch basin one into reservoir two. The electrical water pumps run off the electrical generators from spillway.

7. Second water reservoir fills up with water to spillway two.

8. Water opening onto spillway two spills over the spillway two, down the dam two over generator fins turning the generators causing electricity.

9. Spillway generator fins turn when the water from the spillway two spills down the dam turning the generators causing the electricity.

10. Electrical generator housing areas. Electrical generators are housed on top of one another and side by side in side the dam.

11. Catch basin two catches the water that spills down the spillways two over the generator fins. Catch basin two fills up to correct water levels.

12. One way electrical pumps that are built into the catch basin two walls pump the water out of the catch basin two, into reservoir three. The electrical water pumps run off the electrical generators from spillway.

13. Third water reservoir fills up with water to spillway.

14. Water opening onto spillway three spills over the spillway three, spills down the dam turning the generators making the electricity.

15. Spillway generator fins turn when the water from the spillway three spills down the dam turning the generators causing the electricity.

16. Electric generator housing areas. Electrical generators are housed on top of one another and side by side in side the dam.

17. Catch basin three catches the water that spills down the spillway three over the generators fin. Catch basin three fills up to correct water levels.

18. One way electrical water pumps that are built into the catch basin walls pump the water out of the catch basin three, into reservoir four. The electrical water pumps run off the electrical generators from spillway.

19. Fourth reservoir is higher than reservoir one, this creates back spill from reservoir four back into reservoir one. The reservoir four fills up with water and is higher than reservoir one, the water runs down back spillway into reservoir one. From reservoir one into spillway one.

20. Back spillway from the fourth reservoir down the back spillways into reservoir one.

21. First, second, and third first generator level.

22. Over flow.

23. W=water flow.

### DETAILED DESCRIPTION OF THE INVENTION

1. The Hydro Electrical Plant, has a process that makes the invention unique. This will show in detail the way the process works and the different ways the Hydro Electrical Plant process can be used. For one, in the ocean and big lake the hydro electrical plant can be submerged. The top of the plant will brake the surface, this will allow the gravity of earth to pull the water from the main water source, the water falls throw the spillways down into the plant like a water fall. The water fall turns the generators that are built into the walls of the plant that create the electrical energy. The water fall down to the bottom into the catch basin areas. The electricity from the electrical generators run electrical water pumps that pump water out of the catch basin back into the main water source. This will keep the water from flooding out in the Hydro Electrical Plant. This is just one way the Hydro electrical Plant process works.

2. Another way the Hydro Electrical Plant process is used is the Hydro Electrical plant land. This version of the Hydro Electrical plant land can be built in the hot deserts, mountains and in the cold regions. This version of the Hydro Electrical Plant process uses an artificial water reservoir to produce a spill down a dam. The top spillway our flood gates helps regulate water being spilled down the dam by gravity of the earth. The water running down the dams turn the electrical generators creating the electrical power. This electrical power runs the operations in side the plant. The water from the electrical generators fall into a catch basin. This catch basin fills up with correct water levels, then the electrical water pumps start pumping the water out of the catch basin into a second reservoir. The second reservoir fills up with water from the bottom up to the top back spillway. The top back spillway is built higher then reservoir one so the water from reservoir two will flow back down by the gravity of earth back into reservoir one. This will allow the same water to be used again. When natural evaporation accurse, in the reservoirs the are reservoir balloons.

3. Reservoir balloons inflate and deflate when needed, this helps to control the water level in the reservoirs. When evaporation is to great for the balloons to handle water from an out side source will refill the Hydro Electrical Plant, at this time the reservoir balloons would deflate allowing the water to refill the reservoirs.

4. The Hydro Electrical Plant land has the ability to be connected. This connection application uses the same process as the single dam Hydro electrical plant land, but the difference is that the reservoir two is not the back spill reservoir. Two more dams are built to make it in to a thee dam plant. The back spillway is now in the fourth reservoir. There are sum other applications not shown hear.

1. Hydro Electrical Plant Water Mass Process.
What I claim to be my invention is the way the water flows in the spillways from the main water mass. The water flows threw the spillways down onto the generators and generator fins turning the Hydro Electrical generator making the electricity. Water falls down threw the generators fins into a catch basin at the bottom of the Hydro Electrical Plant. The electricity from the hydro electrical generators power the electrical water pumps that are in the catch basin. The water that is in the catch basin is then pumped out of the catch basin by the electrical water pumps back into the main water source our water mass.

2. Hydro Electrical Plant Land.
What I claim to be my invention is the way the water fills up in the first reservoir one onto the spillways, down the spillways into the electrical generators. The hydro electrical generators fins turn the generators making the electrical energy. The water falls down the dam spillways over the hydro electric generator fins into a catch basin. The catch basin has electrical water pumps that run off the electrical energy from the hydro electrical generators. The electrical water pumps, pump water out of the catch basin into the second reservoir. The second reservoir fills up with water to the top of the back spillway. The second reservoir is built higher than reservoir one this creates back spill down back spillway. The back spillway runs from the top of second reservoir down to the first reservoir

3. Reservoir Balloons.
What I claim to be my invention is under water inflatable balloons. The Reservoir Balloons inflate and deflate under the water controlling the water level up and down.

4. Connection Application of the Hydro Electrical Plant.
What I claim to be my invention is the connection applications of the Hydro electrical plant. I will use the three dam application to show a type of connection of the Hydro Electrical Plant. This will show a connection of dam and hydro electrical generators. The connection application can be built side by side, the more Hydro Electrical Plants built side by side the more dams and generators will be producing electrical power.
